(19) United States
(12) Patent Application Publication
(10) Pub. No.: US 2008/0057907 A1
(43) Pub. Date: Mar. 6, 2008

(54) Service Usage Control System, Service Usage Controller, Method For The Same, Computer Readable Medium For The Same, And Computer Data Signal of The Same

(75) Inventor: Yukio Yamakawa, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/736,641

(22) Filed: Apr. 18, 2007

(30) Foreign Application Priority Data
Sep. 6, 2006 (JP) 2006-241041

(51) Int. Cl. H04M 1/66

(52) U.S. Cl. 455/411

(57) ABSTRACT

A service usage control system has: an image processor; and a service usage controller; wherein the image processor includes: an authentication information acceptor that accepts input of authentication information; an authentication information transmitter that transmits the authentication information to the service usage controller; and an identifying information transmitter that transmits identifying information for identifying the image processor to the service usage controller; and the service usage controller includes: an authentication information receiver that receives the authentication information from the image processor; an identifying information receiver that receives the identifying information from the image processor; an authenticator that performs authentication in accordance with the authentication information; and a processor that performs processing for enabling the image processor identified by the identifying information to use a predetermined service if the authentication is successful.

### CROSS-REFERENCE TO RELATED APPLICATIONS

This application is based on and claims priority, under 35 USC 119, from Japanese Patent Application No. 2006-241041, filed on Sep. 6, 2006.

### BACKGROUND

1. Technical Field

The present invention relates to a service usage control system, a service usage controller, a method for the same, a computer readable medium for the same, and a computer data signal of the same.

2. Related Art

A system for using a service on the Internet from a multi-function peripheral having a scanner function, a printer function, a facsimile function, and the like is known.

### SUMMARY

According to one aspect of the present invention, there is provided a service usage control system having: an image processor; and a service usage controller; wherein the image processor includes: an authentication information acceptor that accepts input of authentication information; an authentication information transmitter that transmits the authentication information to the service usage controller; and an identifying information transmitter that transmits identifying information for identifying the image processor to the service usage controller; and the service usage controller includes: an authentication information receiver that receives the authentication information from the image processor; an identifying information receiver that receives the identifying information from the image processor; an authenticator that performs authentication in accordance with the authentication information; and a processor that performs processing for enabling the image processor identified by the identifying information to use a predetermined service if the authentication is successful.

### BRIEF DESCRIPTION OF THE DRAWINGS

Exemplary embodiments of the present invention will be described in detail by reference to the following figures, wherein:

FIG. 1 is a block diagram showing the overall configuration of a system including a service usage control system according to an exemplary embodiment;

FIG. 2 is a block diagram showing functional configurations of an image processor and an integrated service server;

FIG. 3 is a diagram showing the contents of information stored in an information management server;

FIG. 4 is a sequence diagram showing operations of the system according to the exemplary embodiment when service usage is set;

FIG. 5 is a diagram showing a first charged service usage setting page; and

FIG. 6 is a diagram showing a second charged service usage setting page.

### DETAILED DESCRIPTION

Exemplary embodiments of the present invention will be described below with reference to the drawings.

### [Overall Configuration]

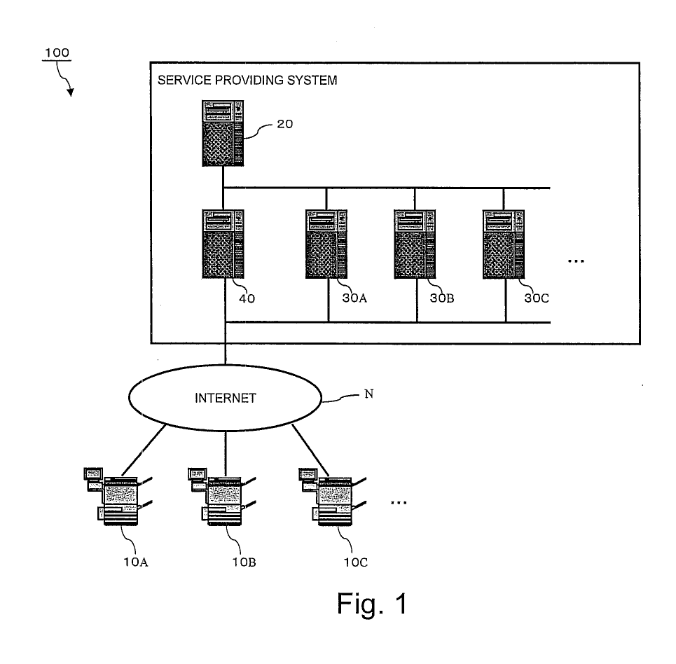

FIG. 1 is a block diagram showing the overall configuration of a system 100 including a service usage control system according to an exemplary embodiment. In FIG. 1, the system 100 has one or more image processors 10A, 10B, 10C, . . . (hereinafter, collectively called an “image processor 10” as required), an information memory 20, service servers 30A, 30B, 30C, . . . (hereinafter, collectively called a “service server 30”), and an integrated service server 40. The image processor 10 and the information memory 20 are connected with the service server 30 and the integrated service server 40, respectively.

The information memory 20, the service server 30, and the integrated service server 40 can be realized by a proper configuration as required. In the exemplary embodiment, each is realized by one or more computers. The information memory 20, the service server 30, and the integrated service server 40 are managed by the service-serving entity and form a service-serving system. In the exemplary embodiment, the image processor 10, the service server 30, and the integrated service server 40 are connected to a network (here, the Internet) N. In the description below, the information memory 20 is called an information management server 20.

The image processor 10 is a device having a scanner function or a facsimile function. In the exemplary embodiment, it is a multi-function peripheral including two or more of a scanner function, a facsimile function, a printer function, and a copy function.

The information management server 20 is for managing various types of information such as information on the image processor 10 and information on service usage.

The service server 30 is for providing a service for the image processor 10. The service servers 30A, 30B, 30C, . . . provide different services. Here, the services may or may not be charged. The services include a service for receiving a scan file from the image processor 10 and saving it, a service for receiving a scan file and processing it, and a service for receiving a facsimile file and saving it.

The integrated service server 40 is for providing an integrated service for the image processor 10. In the exemplary embodiment, the integrated service server 40 has a function as a service usage controller for controlling usage of a service by the image processor 10.

### [Functional Configurations of the Image Processor and the Integrated Service Server]

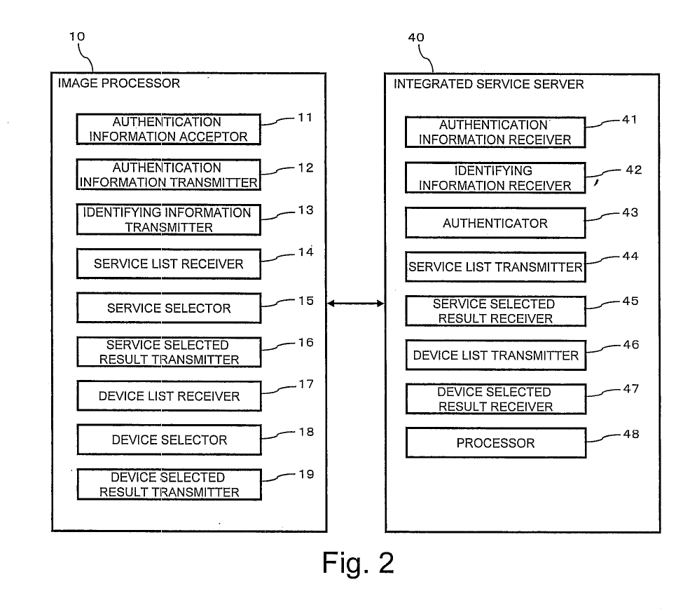

FIG. 2 is a block diagram showing functional configurations of the image processor 10 and the integrated service server 40. With reference to FIG. 2, the functional configurations of the image processor 10 and the integrated service server 40 will be described below.

The image processor 10 includes an authentication information acceptor 11, an authentication information transmitter 12, an identifying information transmitter 13, a service list receiver 14, a service selector 15, a service selection result transmitter 16, a device list receiver 17, a device selector 18, and a device selection result transmitter 19.

The authentication information acceptor 11 accepts input of authentication information. In the exemplary embodiment, the authentication information acceptor 11 accepts input of a user ID and a password from a user via a user interface (not shown) (for example, an operation panel, and hereinafter called “UI”) of the image processor 10. Here, the authentication information is for accessing the integrated service server 40, issued from a service provider to a user in accordance with a contract between the user and the service provider. For example, the authentication information is issued to a purchaser or lesser in accordance with a contract (purchasing contract or lease agreement) of the image processor 10.

The authentication information transmitter 12 transmits to the integrated service server 40 the authentication information accepted by the authentication information acceptor 11.

The identifying information transmitter 13 transmits to the integrated service server 40 identifying information for identifying the image processor 10. In the exemplary embodiment, when transmitting the user ID and the password, the identifying information transmitter 13 transmits to the integrated service server 40 a serial number preset for the image processor 10. Transmission of the identifying information is not limited to the above-mentioned timing and only needs to be performed at an appropriate timing.

The service list receiver 14 receives a list of services that can be available for the image processor 10 from the integrated service server 40.

The service selector 15 selects a service from the list of services received by the service list receiver 14. Specifically, the service selector 15 receives selection of a service from a user via the UI.

The service selection result transmitter 16 transmits to the integrated service server 40 the selection result of the service by the service selector 15.

The device list receiver 17 receives from the integrated service server 40 a list of image processors to be described later.

The device selector 18 selects an image processor from the list of image processors received by the device list receiver 17. Specifically, the device selector 18 accepts selection of an image processor from a user via the UI.

The device selection result transmitter 19 transmits a selection result of the image processor selected by the device selector 18 to the integrated service server 40.

The integrated service server 40 has an authentication information receiver 41, an identifying information receiver 42, an authenticator 43, a service list transmitter 44, a service selection result receiver 45, a device list transmitter 46, a device selection result receiver 47, and a processor 48.

The authentication information receiver 41 receives the above-mentioned authentication information from the authentication information transmitter 12 of the image processor 10.

The identifying information receiver 42 receives the above-mentioned identifying information from the identifying information transmitter 13 of the image processor 10.

The authenticator 43 performs authentication on the basis of the authentication information received by the authentication information receiver 41. Specifically, the authenticator 43 determines validity of the authentication information by comparing information for authentication registered in advance in the information management server 20 and the received authentication information.

The service list transmitter 44 transmits to the image processor 10 a list of services that can be made available for the image processor 10 identified by the identifying information (i.e., services that can be set for use), in accordance with at least one of the authentication information received by the authentication information receiver 41 and the identifying information received by the identifying information receiver 42. For example, the authentication information and information for determining services that can be set for use (for example, a rank of the contract) are registered in association with each other in the information management server 20, and the service list transmitter 44 creates the above-mentioned list of services by reference to the above-mentioned information in the information management server 20 and the authentication information and transmits the list. For example, the identifying information and information for determining services that can be set for use (for example, configuration information of a device) are registered in association with each other in the information management server 20, and the service list transmitter 44 creates the above-mentioned list of services in accordance with the above-mentioned information in the information management server 20 and the identifying information and transmits the list. The service list transmitter 44 may create the above-mentioned list of services in accordance with both the authentication information and the identifying information by referencing the above-mentioned information in the management server 20, and transmit the list.

The service selection result receiver 45 receives the selection result of the service from the service selection result transmitter 16 of the image processor 10.

The device list transmitter 46 transmits to the image processor 10 a list of image processors associated with the authentication information received by the authentication information receiver 41. Specifically, the authentication information and the list of image processors are registered in the information management server 20 in association with each other. For example, if a contract (purchasing contract or lease agreement) is made for multiple image processors 10, the authentication information is issued for the purchaser or leaser, and the authentication information and attribute information (serial number or the like) on the multiple image processors 10 are associated with each other and registered in the information management server 20. The device list transmitter 46 transmits to the image processor 10 the list of image processors associated with the received authentication information by referring to the above-mentioned information in the information management server 20. It should be noted that the device list transmitter 46 may transmit to the image processor 10 a list of image processors associated with the identifying information received by the identifying information receiver 42. In this case, for example, the identifying information and the list of image processors are registered in the information management server 20 in association with each other, and the device list transmitter 46 transmits to the image processor 10 the list of image processors associated with the received identifying information by referring to the above-mentioned information in the information management server 20.

The device selection result receiver 47 receives the selection result of an image processor from the device selection result transmitter 19 of the image processor 10.

If the authentication by the authenticator 43 is successful, the processor 48 performs processing for enabling the image processor 10 to use a predetermined service that is identified by the identifying information received by the identifying information receiver 42. Here, the predetermined service is a service provided by the service server 30 on the Internet. The processing for enabling service usage includes processing for setting an image processor side so as to enable the image processor 10 to request a service, and processing for setting a service serving system side (for example, information in the information management server 20) so as to enable the image processor 10 to receive a service.

In the exemplary embodiment, the processor 48 performs processing for making the selected service available in accordance with the selection result of the service received by the service selection result receiver 45. In the exemplary embodiment, the processor 48 enables the selected image processor in addition to the image processor identified by the identifying information to use the service in accordance with the selection result of the image processor received by the device selection result receiver 47.

In the exemplary embodiment, the processor 48 inquires, of an acknowledger associated with the authentication information received by the authentication information receiver 41, whether or not the service is to be enabled, and if the processor 48 receives from the acknowledger a response indicating that the service is to be enabled, the processor 48 performs processing for enabling the service. Specifically, the authentication information and the contact address (mail address or the like) of the acknowledger are registered in the information management server 20 in association with each other, and the processor 48 inquires of the acknowledger by an appropriate communication method such as an electric mail by referring to the above-mentioned information in the information management server 20 and receives a response from the acknowledger. It should be noted that the processor 48 may inquire, of an acknowledger associated with the identifying information, whether or not the service is to be enabled, and if the processor 48 receives from the acknowledger a response indicating that the service is to be enabled, the processor 48 performs processing for enabling the service. In this case, for example, the identifying information and the contact address (mail address or the like) of the acknowledger are registered in the information management server 20 in association with each other, and the processor 48 inquires of the acknowledger by an appropriate communication method such as an electric mail by referring to the above-mentioned information in the information management server 20 and receives a response from the acknowledger.

Each of the functions of the image processor 10 and the integrated service server 40 is realized by reading a program recorded in a recording medium such as a ROM (Read Only Memory), a hard disk, or the like to a main memory and executing the read program by a CPU (Central Processing Unit). Such a program may be distributed with an appropriate recording medium such as CD-ROM or may be distributed via a network. Some or all of the functions of each of the devices 10 and 40 may be realized by other configurations such as a dedicated hardware device.

### [Storage Contents of the Information Management Server]

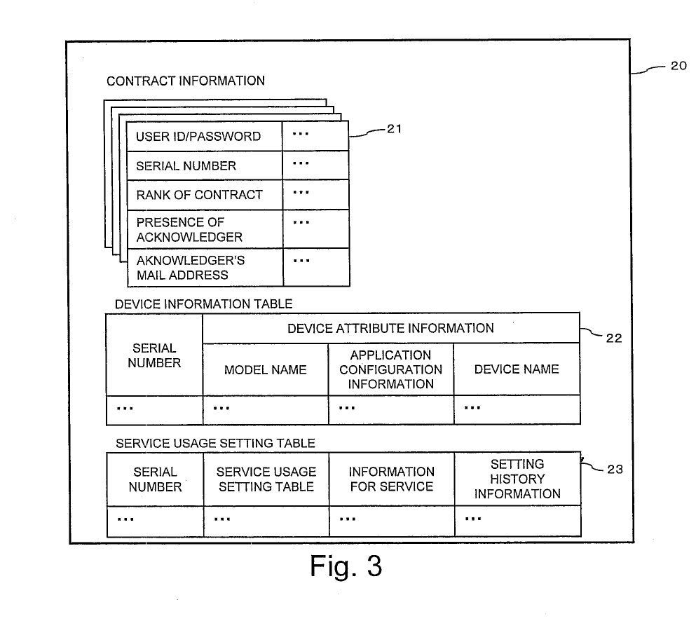

FIG. 3 is a diagram showing the contents of information stored in the information management server 20. The storage contents of the information management server 20 will be described in detail below with reference to FIG. 3. As shown in FIG. 3, the information management server 20 stores, for each contract, contract information 21, a device information table 22, and a service usage setting table 23.

The contract information 21 is information on the contract (purchasing contract or lease agreement) of the image processor 10, created for each contract and registered in the information management server 20. As shown in FIG. 3, the contract information 21 includes a user ID/password relating to the contract, a serial number of one or more image processors 10 which are the object of the contract, a rank of the contract, the presence of an acknowledger, and a mail address of the acknowledger. Here, for example, the user ID/password relating to the contract may be issued when the contract is made, but they can be newly registered/changed/deleted in accordance with the desire of the user or the like. For example, upon receiving from the image processor 10 or the PC an instruction for newly registering/changing/deleting with the user ID/password issued when the contract is made, the integrated service server 40 performs new registration/change/deletion of the user ID/password. Each of the user ID/password can be added with function limitations, as required. The function limitations include limitations on the kinds of services that can be set for use and the like. The presence and the mail address of the acknowledger can be set when the contract is made and can be newly registered or changed after the contract is made.

As shown in FIG. 3, the device information table 22 has, for each image processor, a serial number and device attribute information of the image processor 10 registered in association with each other. Here, the device attribute information includes the name of the machine, appliance configuration information, a name set by a user to identify a device, and the like. The information on the image processor 10 is registered in the device information table 22 immediately after the contract of the image processor 10 is made, for example.

As shown in FIG. 3, the service usage setting table 23 has, for each image processor, a serial number of the image processor 10 and a service available for the image processor 10 registered in association with each other. Information for service used in the service and setting history information indicating a history of the service usage setting are also registered for each combination of serial number and service. The setting history information is information indicating, for example, setting date and time, a person performing setting, and an image processor used for setting.

Some or all the information saved in the information management server 20 may be viewed from the image processor 10 or the PC. For example, if the service usage setting table is enabled for viewing, the user becomes able to check who set which service, as well as from which machine and at what time.

### [Operation When Service Usage is Set]

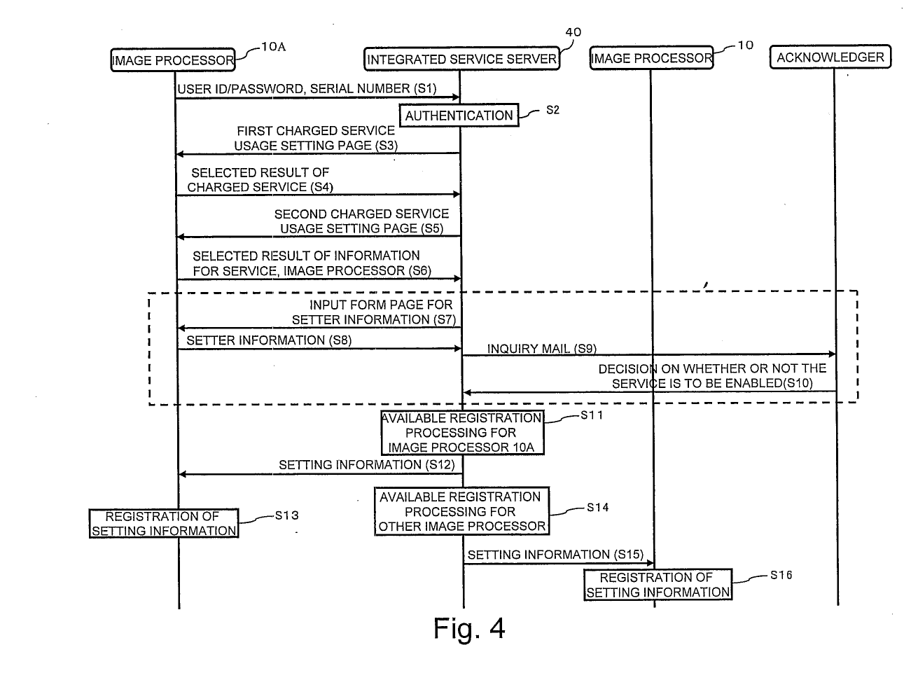

FIG. 4 is a sequence diagram showing operations of the system 100 according to the exemplary embodiment when service usage is set. By reference to FIG. 4, operations of the system 100 when service usage is set will be described in detail. Here, it is assumed that communication between the image processor 10 and the integrated service server 40 is realized by communication between a Web browser on the image processor 10 and a Web server on the integrated service server 40.

When a user is to use a charged service on the Internet from the image processor 10A, the user sets an Internet connection of the image processor 10A and then accesses the integrated service server 40 from the image processor 10A. Then, a top page of the integrated service site is displayed on a UI screen of the image processor 10A. When the user presses a button labeled “set to use charged services” on the top page, a page for prompting the user to input the user ID and password is displayed. When the user inputs the user ID and password in this page and presses an “OK” button, the image processor 10A sends to the integrated service server 40 the input user ID/password and the serial number of the image processor 10A (S1).

Upon receiving the user ID/password and the serial number, the integrated service server 40 performs authentication on the received user ID/password by referring to the information service server 20 (S2). Specifically, if contract information including the received user ID/password is present, the integrated service server 40 determines that the authentication is successful, whereas if the contract information is not present, the integrated service server 40 determines that the authentication fails. The integrated service server 40 may perform authentication based on a combination of the user ID/password and the serial number, from the viewpoint of improving accuracy of the authentication.

If the authentication fails, the integrated service server 40 causes the accessing image processor 10A to display an error message.

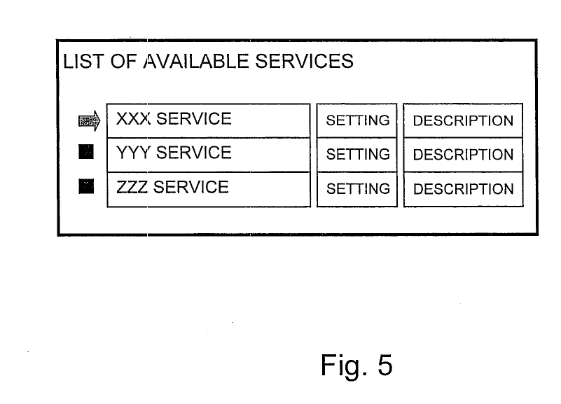

On the other hand, if the authentication is successful, the integrated service server 40 determines a charged service available for the image processor 10A on the basis of the rank of the contract included in the contract information 21 according to the received user ID and the device attribute information associated with the received serial number, by referring to the information management server 20. Then, the integrated service server 40 causes the image processor 10A to display the first charged service usage setting page as shown in FIG. 5 including a list of the determined charged services (S3).

When the user selects a desired charged service in the first charged service usage setting page; specifically, when a “setting” button corresponding to the desired charged service is pressed, the image processor 10A transmits a selection result of the charged service to the integrated service server 40 (S4).

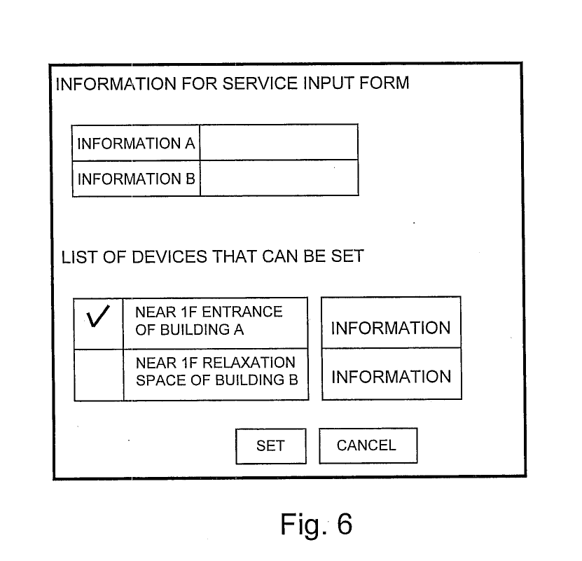

Upon receiving the selection result of the charged service, the integrated service server 40 determines the serial number (i.e., the image processor 10 with the contract) included in the contract information 21 according to the received user ID, by referring to the information management server 20. Then, the integrated service server 40 determines the image processor 10 (except for the accessing image processor 10A) that can set and use the selected charged service among the determined image processors 10, by reference to the device information table 22 of the information management server 20. The integrated service server 40 causes the image processor 10A to display the second charged service usage setting page as shown in FIG. 6 (S5). As shown in FIG. 6, the second charged service usage setting page includes a part for accepting an input of information for service used in the selected charged service, and a list of the determined image processors. In FIG. 6, a list of names of image processors is displayed as the list of image processors. The information for service includes necessary information or additional information for using the service. The contents of the information for service are determined in accordance with the service. The information for service need not be input for some services.

In the second charged service usage setting page, the user inputs the information for service. If the user has the image processor 10 desired to use the selected charged service other than the currently operating images processor 10A, the user selects the desired image processor from the list of image processors. Then, the user presses a “setting” button on the second charged service usage setting page. Then, the image processor 10 transmits to the integrated service server 40 the input information for service and a selection result of the image processor (S6).

Upon receiving the information for service and the selection result of the image processor, the integrated service server 40 determines whether an acknowledger is set in the contract information 21 according to the received user ID, by referring to the information management server 20, and if no acknowledger is set, performs the processing after step S11, and if an acknowledger is set, performs the processing after step S7.

### (The Case Where No Acknowledger is Set)

The integrated service server 40 performs processing for making the selected charged service available for the accessing image processor 10A and the selected image processor 10 (if any is selected).

Specifically, the integrated service server 40 performs available registration processing for the accessing image processor 10A (S11). That is to say, the integrated service server 40 registers, in the service usage setting table 23 of the information management server 20 and in association with one another, the serial number of the image processor 10A, the selected charged service, the input information for service, and the setting history information. Then, the integrated service server 40 transmits the setting information to the accessing image processor 10A (S12), and the image processor 10A receives the setting information and registers it in its available service table (S13). Here, the setting information includes address information for accessing the charged service (for example, the URL of the service server 30) and the name of the charged service (a character string).

The integrated service server 40 performs the available registration processing for the selected image processor 10 (S14). That is to say, for each of the selected image processors 10, the integrated service server 40 registers, in the service usage setting table 23 of the information management server 20 and in association with one another, the serial number of the image processor 10, the selected charged service, the input information for service, and the setting history information. Then, the integrated service server 40 transmits the setting information to each image processor 10 (S15), and each image processor 10 receives the setting information and registers the setting information in its available service table (S16). Here, the transmission for the setting information to each image processor 10 is performed by an appropriate communication method. For example, the integrated service server 40 may transmit the setting information in response to the inquiry from the image processor 10, or may push-transmit the setting information to the image processor 10 via a cellular phone line or the like.

### (The Case Where an Acknowledger is Set)

The integrated service server 40 transmits to the image processor 10A to be displayed an input form page for prompting input of setter information on the setter (name, position, employee number, mail address, phone number, and the like) (S7).

When the user inputs the information on the setter in the input form page and presses an “OK” button, the image processor 10A transmits the input information on the setter to the integrated service server 40 (S8).

Upon receiving the information on setter, the integrated service server 40 transmits to an acknowledger's mail address set in the contract information 21 a mail for inquiring whether or not the charged service can be used, including the information on the setter (S9).

When receiving the mail; for example, from the acknowledger's PC, the acknowledger accesses the URL (the URL of a predetermined page managed by the integrated service server 40) described in the mail. Then, the acknowledger inputs in the page a one time password described in the mail, inputs the decision on whether or not the service is to be enabled, and presses an “OK” button. Then, the acknowledger's PC transmits to the integrated service server 40 the input one time password and the decision on whether or not the service is available (S10).

When receiving the one time password and the decision on whether or not the service is to be enabled, and if the authentication based on the one time password succeeds and the service is determined to be enabled, the integrated service server 40 performs processing for enabling the accessing image processor 10A and the selected image processor 10 (if any is selected) to use the selected charged service (S11 to S16). If the authentication fails or the service is determined to be unavailable, the processing for enabling the charged service is not performed.

The integrated service server 40 notifies the result on whether or not the service is to be enabled to the setter's mail address and the accessing image processor 10A. Therefore, the result on whether or not the service is to be enabled can be checked by the setter's PC and the image processor 10A.

### [Operation When a Service is Used]

Operations of the system 100 when a service is used will be described in detail below. The image processor 10 causes the UI to display a menu screen including “copy,” “facsimile,” “scan,” and “service.” When the user selects “service” on the menu screen, the image processor 10 causes the UI to display a screen of a list of the names of the charged services registered in its available service table (character string). When the user selects a desired charged service on the screen of the list, the image processor 10 causes the UI to display a message corresponding to the charged service (here, it is assumed to be a message of “scan the document you desire to be served”). When the user performs the scan operation in accordance with the message, the image processor 10 scans the document and creates a scan file. Then, the image processor 10 transmits the scan file and its serial number to an access point (here, the service server 30A is assumed to be the access point) of the selected charged service on the basis of the URL of the charged service registered in the available service table.

Upon receiving the scan file and the serial number, the service server 30A determines whether the charged service of the service server 30A is associated with the serial number, by referring to the service usage setting table 23 of the information management server 20. Then, if association is found, the service server 30A performs predetermined processing (saving, processing, and the like) for the scan file. If association is not found, the service server 30A notifies the accessing image processor 10 of an error without executing the predetermined processing for the scan file.

The charged service is charged to the user in addition to the maintenance charge of the image processor 10, for example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A service usage control system comprising:
an image processor; and
a service usage controller; wherein
the image processor comprises:
an authentication information acceptor that accepts input of authentication information;
an authentication information transmitter that transmits the authentication information to the service usage controller; and
an identifying information transmitter that transmits identifying information for identifying the image processor to the service usage controller; and
the service usage controller comprises:
an authentication information receiver that receives the authentication information from the image processor;
an identifying information receiver that receives the identifying information from the image processor;
an authenticator that performs authentication in accordance with the authentication information; and
a processor that performs processing for enabling the image processor identified by the identifying information to use a predetermined service if the authentication is successful.

2. The service usage control system according to claim 1, wherein
the image processor further comprises:
a service list receiver that receives from the service usage controller a list of services that can be made available for the image processor;
a service selector that selects a service from the list of services; and
a service selection result transmitter that transmits a selection result of the service to the service usage controller;
the service usage controller further comprises:
a service list transmitter that transmits the list of services to the image processor in accordance with at least one of the authentication information and the identifying information; and
a service selection result receiver that receives the selection result of the service from the image processor; and
the processor performs processing for enabling the selected service to be used, in accordance with the selection result of the service.

3. The service usage control system according to claim 1, wherein
the image processor further comprises:
a device list receiver that receives a list of image processors from the service usage controller;
a device selector that selects an image processor from the list of image processors; and
a device selection result transmitter that transmits a selection result of the image processor to the service usage controller;
the service usage controller further comprising:
a device list transmitter that transmits to the image processor a list of image processors associated with at least one of the authentication information and the identifying information; and
a device selection result receiver that receives the selection result of the image processor from the image processor; and
the processor performs processing for enabling the selected image processor in addition to the image processor identified with the identifying information to use the service in accordance with the selection result of the image processor.

4. The service usage control-system according claim 2, wherein
the image processor further comprises
a device list receiver that receives a list of image processors from the service usage controller;
a device selector that selects an image processor from the list of image processors; and
a device selection result transmitter that transmits a selection result of the image processor to the service usage controller;
the service usage controller further comprises:
a device list transmitter that transmits to the image processor a list of image processors associated with at least one of the authentication information and the identifying information; and
a device selection result receiver that receives the selection result of the image processor from the image processor; and
the processor performs processing for enabling the selected image processor in addition to the image processor identified with the identifying information to use the service in accordance with the selection result of the image processor.

5. The service usage control system according to claim 1, wherein
the processor inquires of an acknowledger associated with at least one of the authentication information and the identifying information whether or not a service is to be enabled, and when receiving from the acknowledger a response indicating that the service is to be enabled, performs processing for enabling the service.

6. The service usage control system according to claim 2, wherein
the processor inquires of an acknowledger associated with at least one of the authentication information and the identifying information whether or not a service is to be enabled, and when receiving from the acknowledger a response indicating that the service is to be enabled, performs processing for enabling the service.

7. The service usage control system according to claim 3, wherein
the processor inquires of an acknowledger associated with at least one of the authentication information and the identifying information whether or not a service is to be enabled, and when receiving from the acknowledger a response indicating that the service is to be enabled, performs processing for enabling the service.

8. The service usage control system according to claim 4, wherein
the processor inquires of an acknowledger associated with at least one of the authentication information and the identifying information whether or not a service is to be enabled, and when receiving a response indicating that it is available from the acknowledger, performs processing for enabling the service.

9. A service usage controller, comprising:
an authentication information receiver that receives authentication information from an image processor;
an identifying information receiver that receives from the image processor identifying information for identifying the image processor;
an authenticator that performs authentication in accordance with the received authentication information; and
a processor that performs processing for enabling the image processor identified with the received identifying information to use a predetermined service, if the authentication is successful.

10. The service usage controller according to claim 9, further comprising:
a service list transmitter that transmits a list of services that can be made available for the image processor to the image processor in accordance with at least one of the authentication information and the identifying information; and
a service selection result receiver that receives from the image processor a service selected from the list of services; and
wherein the processor performs processing for enabling the selected service to be used, in accordance with the selection result of the service.

11. The service usage controller according to claim 9, further comprising:
a device list transmitter that transmits to the image processor a list of image processors associated with at least one of the authentication information and the identifying information; and
a device selection result receiver that receives from the image processor an image processor selected from the list of image processors;
wherein the processor performs processing for enabling the selected image processor in addition to the image processor identified with the identifying information to use the service, in accordance with the selection result of the image processor.

12. A method for performing processing for enabling an image processor to use a service, comprising:
receiving authentication information from an image processor;
receiving from the image processor identifying information for identifying the image processor;
performing authentication in accordance with the received authentication information, and,
performing processing for enabling the image processor identified by the received identifying information to use a predetermined service, if the authentication is successful.

13. A computer readable medium storing a program causing a computer to execute a process for performing processing for enabling an image processor to use a service, the process comprising:
receiving authentication information from an image processor;
receiving from the image processor identifying information for identifying the image processor;
performing authentication in accordance with the received authentication information; and
performing processing for enabling the image processor identified with the received identifying information to use a predetermined service, if the authentication is successful.

14. A computer data signal embodied in a carrier wave for enabling a computer to perform a process for performing processing for enabling an image processor to use a service, the process comprising:
receiving authentication information from an image processor;
receiving from the image processor identifying information for identifying the image processor;
performing authentication in accordance with the received authentication information, and
performing processing for enabling the image processor identified with the received identifying information to use a predetermined service, if the authentication is successful.
